(19) United States
(12) Patent Application Publication
(10) Pub. No.: US 2023/0144420 A1
(43) Pub. Date: May 11, 2023

(54) ANIMAL RESCUE DOME FOR POOL SKIMMER

(71) Applicants: Zachari Karantonis, Fallston, MD (US); Dennis G. Haun, Fallston, MD (US)

(72) Inventors: Zachari Karantonis, Fallston, MD (US); Dennis G. Haun, Fallston, MD (US)

(21) Appl. No.: 17/949,809

(22) Filed: Sep. 21, 2022

Related U.S. Application Data
(60) Provisional application No. 63/247,957, filed on Sep. 24, 2021.

(51) Int. Cl. A01K 29/00; E04H 4/12

(52) U.S. Cl. CPC A01K 29/00; E04H 4/1272

(57) ABSTRACT

An animal rescue vault for use inside a pool skimmer well that comprises a multi-legged vault formed of a pliable mesh material and presenting a gradual ramped crown leading upward to a raised peak. The ramped crown is surrounded by sides and elevate atop multiple legs, which presents an island to a struggling animal that raises abruptly then more gradually out of the water vortex. The mesh sides and ramp of the device are easy for the swirling animal to grasp, and yet the mesh construction does not interfere with the recirculation vortex. The device fits in existing skimmers without replacing existing parts.

### CROSS-REFERENCE TO RELATED APPLICATION(S)

The present application derives priority from U.S. patent application Ser. No. 63/247,957 filed Sep. 24, 2021.

### BACKGROUND OF THE INVENTION

### 1. Field of the Invention

The present invention relates to pool accessories in general, and more specifically to a rescue dome for animals configured to be placed in a swimming pool skimmer.

### 2. Description of the Background

Small animals such as mice, frogs and the like sometimes mistake a pool for a pond and they jump in. However, the raised edges prevent them from jumping out. Without assistance they would drown. There are a variety of known solutions to this problem. For example, it is known to attach a rope to the pool edge and float the other end in the water to help animals climb out.

U.S. Pat. No. 5,377,623 issued in 1995 to J. A. Parr and U.S. Pat. No. 5,862,541 issued to Mailhot both disclose apparatus for rescuing frogs from swimming pools. The devices are a small platform attached to the pool ladder or edge.

U.S. Pat. No. 9,121,190 to Douglas issued Sep. 1, 2015 shows a similar animal rescue step for a swimming pool.

U.S. Pat. No. 5,320,368 to Koerkel issued Jun. 14, 1994 shows a floating rescue island.

The foregoing and like devices hang from the side of the pool and are aesthetically and physically obtrusive. What is needed is an animal rescue device that is unobtrusive.

It is known to attach animal rescue device in the wells of pool skimmers. For example, U.S. Pat. No. 4,325,462 to Gouzos issued 20 Apr. 1982 shows a ladder with its lower end situated in the recirculation water and its upper end leading to an exit aperture in the skimmer port through which the animals can escape.

United States Patent Application 20090120856 by Meagher published May 14, 2009 shows a helical ramp that leads up through the skimmer cover.

Although the foregoing devices are meant for use inside the skimmer well they are relatively complicated, replace existing skimmer parts, and often ineffectual. This is because they provide animals with a single point of exit from the recirculation water. Unfortunately the water inside the recirculation well is typically swirling around in a vortex and it is quite difficult for animals to grab onto the end of a ladder or ramp.

Therefore, what is needed is a device for insertion into an existing pool recirculation well or skimmer that provides a raised island approachable by a partially-surrounding ramp that, despite its breadth, does not interfere with the recirculation vortex.

### SUMMARY OF THE INVENTION

Accordingly, it is an object of the present invention to provide an improved animal rescue device for use inside a pool skimmer well that provides a raised island approachable by a broad gradual ramp for easier access by entrapped animals.

Another object is to provide an animal rescue device as described above that does not interfere with the recirculation vortex, and that assists in catching debris like leaves and other organic material blown into the pool.

Another object is to provide an animal rescue device as described above that fits in existing skimmers without replacing existing parts.

Yet another object is to provide an animal rescue device as described above that is simple in design and inexpensive to manufacture.

These and other features and benefits are achieved with an improved animal rescue device for use inside a pool skimmer well that comprise a multi-legged vault formed of a pliable mesh material and presenting a gradual ramped crown leading upward to a raised peak. The device is substantially oval or circular and may be inserted into a conventional circular pool skimmer well. Once inserted the mesh sides elevate the ramped crown up from and out of the water vortex. The upper sides of the device are also a surrounding mesh for the swirling animal to grasp. The animal need only grasp the mesh crown or sides and climb to the raised peak to escape. The mesh construction raised above multi-legged (e.g., quadruped) base does not interfere with the recirculation vortex, and the device fits in existing skimmers without replacing existing parts. In an embodiment the device is a unitary molded component and is simple and inexpensive to manufacture.

For a more complete understanding of the invention, its objects and advantages, refer to the remaining specification and to the accompanying drawings.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top perspective view of a pool skimmer 10 with top cover 11 partially removed to reveal the animal rescue device 100 inside.

FIG. 2 is a top perspective view of the removed top cover 11.

FIG. 3 is a side perspective view of an animal rescue device 100.

FIG. 4 is a side view of the animal rescue device 100 of FIGS. 1 and 3.

FIG. 5 is a top view of the animal rescue device 100 of FIGS. 1, 3 and 4.

FIG. 6 is a front view of the animal rescue device 100 of FIGS. 1 and 3-5.

### DETAILED DESCRIPTION OF THE PREFERRED EMBODIMENTS

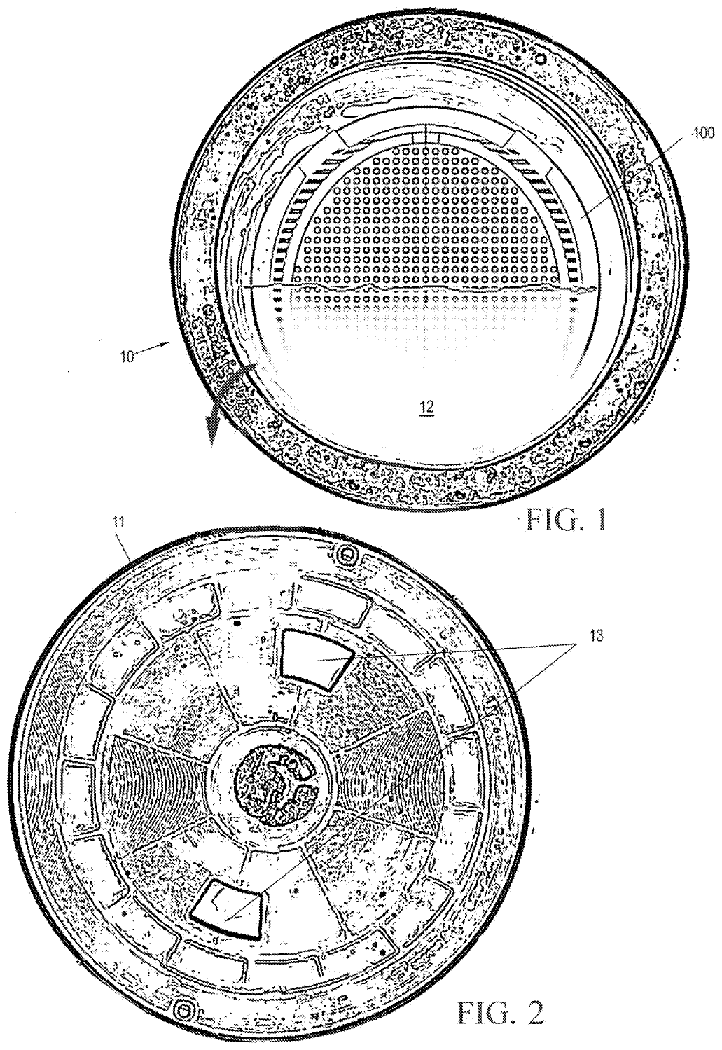

The present invention is simple, easy to install animal rescue device for use inside a conventional pool skimmer well. FIG. 1 shows a typical pool skimmer 10 for a swimming pool with top cover 11 partially removed to reveal the animal rescue device 100 inside, and FIG. 2 shows the removed top cover 11.

The skimmer 10 has an entryway throat (obscured) leading into a skimmer well with an open top closed by a top cover 11 and a pump outlet port at the bottom. The pump outlet port leads to a recirculating pump and filtering mechanism (not shown) that provides a constant recirculation of the pool water 12 into the pool. The entryway throat is often provided with an upright vertically self-adjusting flap that is hinged to the throat. In addition, a removable strainer basket (not shown) may be disposed within the well, and the existing skimmer portal cover 11 may have open viewing windows 13 for observing debris inside. The water passing through the strainer basket is drawn into the pump outlet port and into the recirculating pump and filtration system. After filtering the water is reintroduced into the pool, typically at the bottom of the skimmer well 10. The inward/outward flow creates a substantial vortex of water around and above the removable strainer basket that poses a substantial risk of drowning to any entrapped animals that may have fallen into the pool.

The animal rescue device 100 according to the present invention is placed inside the otherwise conventional pool skimmer 10 and provides a ramped mesh island that rises above the water level and can be grasped easily from any angle as the animal swirls. The device 100 includes a multi-legged base that supports the mesh island, the latter including a ramped facing that dips beneath the multi-legged base, and progressively rises there from to an elevated peak by which animals can raise themselves above the swirling water, rest, and escape through the skimmer portal.

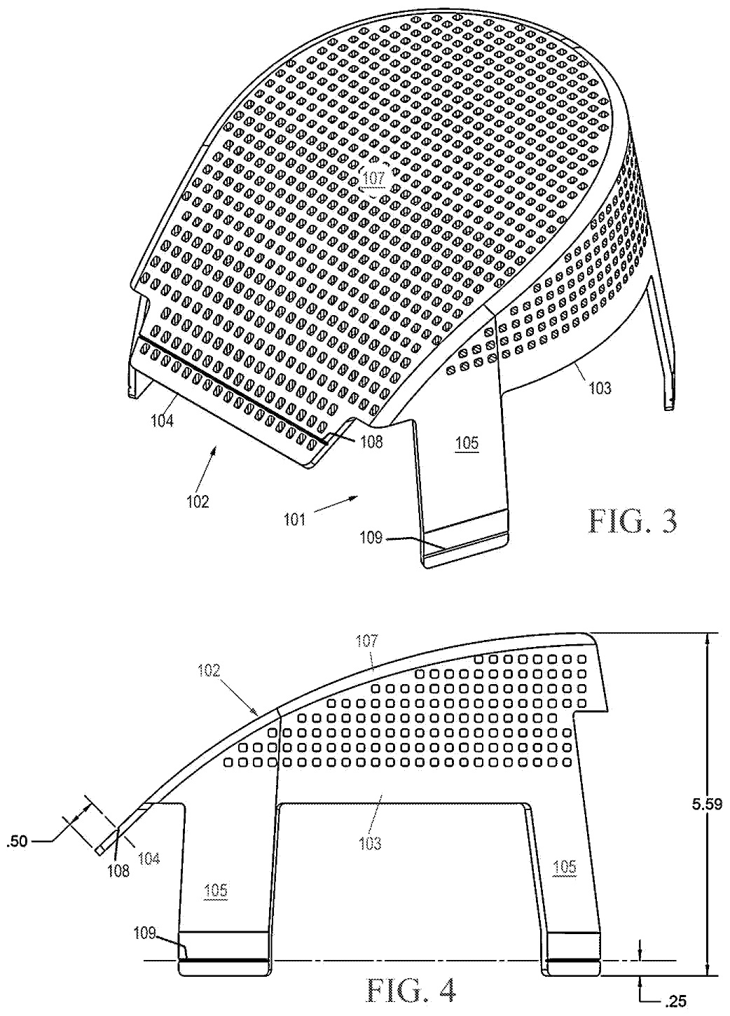

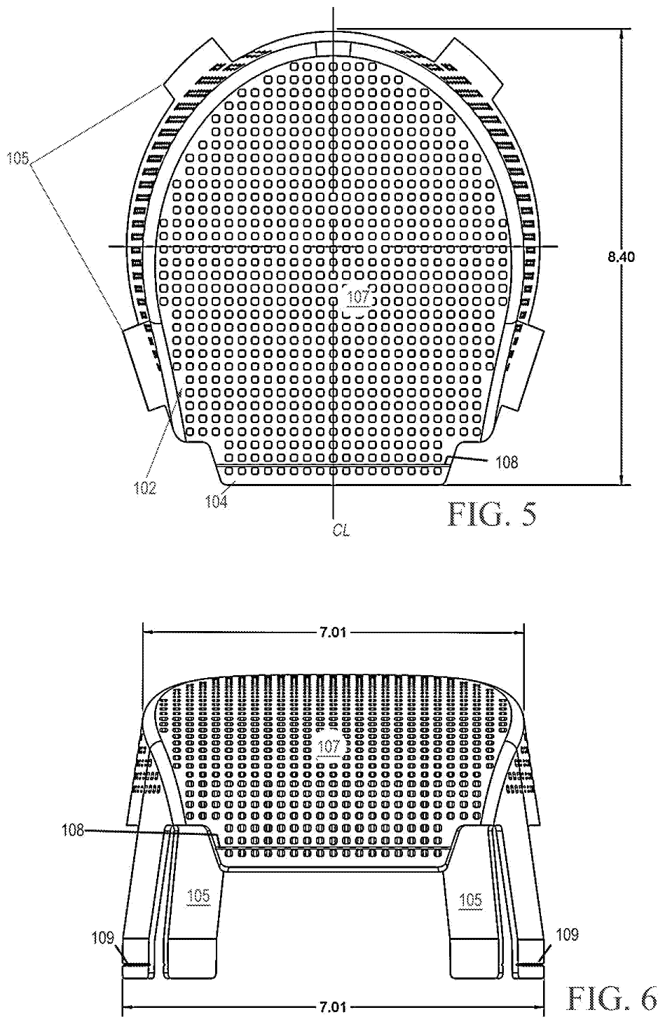

With additional reference to FIGS. 3-6 the animal rescue device 100 comprises a substantially oval or circular free-standing multi-legged vault formed of a pliable mesh material such as perforated molded plastic. The rescue device 100 has a multi-legged lower base 101 that supports an upper section 102 formed as a graduated ramp partially surrounded by a sidewall 103. The sidewall 103 is arched, partially circumscribing an oval, and of increasing thickness running from a pair of distal cusps to a peak occurring at a symmetric centerline CL (FIG. 5). A ramped surface 107 spans the top of the sidewall 103, the ramped surface 107 extending at one end from a lip 104 that protrudes below the sidewall 103 to an opposing end elevated to the peak at CL. The lower lip 104 is designed to dip below the sidewall 103 into the water. The rescue device 100 stands on multiple legs 105 that elevate the upper section 102 above the strainer basket and to allow debris to pass through. In total the device 100 is vaulted, loosely dome-shaped, and the combined legs 105, sidewall 103 and ramped surface 107 create a reinforcing framework sized to conform to the existing removable strainer basket so as to sit there atop. In a preferred embodiment the lower base 101 is a quadruped, with four (4) legs 105 that elevate the device 100 for unobstructed water flow and so that debris can pass through and into the skimmer 10 below. The legs 105 are broad, flat and spaced at angular intervals around a circle for maximum stability, and angularly oriented about the circle to minimize obstruction to circular water flow within the skimmer 10. The quadruped legs 105 are arranged in two pair, one pair of legs 105 on each side of the symmetric centerline CL of the sidewall 103. The legs 105 are equi-angularly spaced around the sidewall 103, oriented tangent to the sidewall 103, and preferably flare outward from the sidewall 103 slightly for enhanced stability. The quadruped legs 105 elevate the upper section 102 and sides 103 vertically such that the sides terminate at approximately water level inside skimmer 10. Thus, the upper section 102, albeit partially submerged as seen in FIG. 1, protrudes like an island above water level, and the mesh material presents a ramped crown gradually angling upward from an angle of approximately 45 degrees at water level, to a shallower angle of about 5 degrees at its peak positioned near the backward end. The lip 104 angles upward from slightly beneath water level, projecting forward and downward from upper section 102. The entire device 100 may be integrally-formed in this mesh-dome-shape by injection molding. Alternatively, the entire device 100 may be formed from a flat sheet of plastic mesh inserted into a formed compression mold.

The device 100 is shaped and sized to sit atop the strainer basket, elevating the upper section 102 at least partially above the water, to provide an arched ramp up to the peak. The peak of upper section 102 is elevated well-above the water vortex, and the surrounding mesh of upper section 102 and sides 103 make it easier for a swirling animal to grasp and climb to the peak to rest, and then escape out through the view holes 13 of the existing skimmer portal cover 11 (larger holes may be cut into the existing portal cover 11 if needed).

To accomplish the foregoing, relative dimensions are important. In an embodiment, the upper section is 8.40″ long and spans 7.01″ wide. The peak of the upper section 102 stands 5.59″ high and ramps gradually downward at approximately a 6″ radius of curvature, terminating at the lower edge of lip 104 which stands approximately one third as high as the peak, or 1.87″. The legs 105 elevate the upper section 102 about half as high as the peak, e,g, 2.8.″ Thus, the animal rescue device 100 progressively rises from 1.87″ to the elevated peak of 5.59″, emerging from the water vortex so that animals can raise themselves above the swirling water. The mesh material may be, e.g., perforated molded plastic, and the perforations preferably occupy a majority of the surface area about the entire ramped surface of upper section 102 as well as the surrounding sides 103. The perforation consumes at least 40% of the surface area, and more preferably within a range of from 45-50% to reduce drag. The legs 105 are symmetrically-spaced on opposite sides of the long axis of the oval to provide a balanced footing against the flat circular rim of the existing skimmer basket. The quadruped legs 105 elevate the upper section 102 above the strainer basket and allow debris to pass through. In addition, the legs 105 are oriented substantially along the diameter of the circular rim of the existing skimmer basket. The angles and spacing of legs 105 minimizes drag from the water vortex. The sidewall 103 and ramped surface 107 remain partially submerged about an inch at the lip 104, but at the peak CL protrude like an island above water level. Given the foregoing dimensions the peak CL will rise to within an inch of the viewing windows 13 of the portal cover 11. The surrounding mesh of upper section 102 and sides 103 make it easier for a swirling animal to grasp and climb to the peak to rest, and then escape out through the view holes 13 of the existing skimmer portal cover 11 (FIG. 1).

The foregoing dimensions are well-suited for many existing strainer wells and baskets, but there may be need for slightly smaller dimensions. Toward this end the invention includes offset notches 108, 109 at the lip and legs which provide the ability for a user to truncate the lip 104 and legs 105 in a coordinated manner to adjust the height. Notch 108 spans the lower lip 104, and notches 109 span the lower legs 105, in both cases offset slightly from the distal end. The offset of notch 108 is calculated by Pythagorean theorem based on the offset of notch 109, as if lip 104 were a hypotenuse. Recalling that the lip 104 should dip below the sidewall 103 into the water, a small offset of notches 108 equals a slightly larger coordinated offset of notch 108. Notches 108, 109 allow a convenient measured truncation of lip 104 and legs 105.

One skilled in the art will readily understand that the device 100 need not have an exactly circular cross-section provided that it functions to sit atop strainer basket and stay out of the way of the gate. This the device 100 may be slightly oval, concave at the front end, or alternately-shaped to serve this purpose. The mesh construction of all sections 102, 103, 104, 105 does not interfere with the recirculation vortex at all, and the device fits in existing skimmers without replacing existing parts.

The animal rescue devices 100 according to the present invention remains inside the otherwise conventional pool skimmer 10 and provides a raised circular mesh island that can be grasped easily from any angle as the animal swirls, and a ramped crown rising to a raised peak by which animals can raise themselves above the swirling water, rest, and escape through the skimmer portal. In addition, the device 100 assists in catching debris like leaves and other organic material blown into the pool and keeps a significant amount of debris from going down into the existing basket and slowing down suction (especially during a windstorm). Since the device 100 is raised on legs with water flow there beneath, debris remains on top.

One skilled in the art will understand that components of embodiments of this disclosure can be formed from any mesh materials suitable for the purposes of this disclosure. For example, components of embodiments can be formed from metals, such as aluminum, rubber coated steel; or plastics or resins. Components of embodiments of this disclosure can be manufactured according to any manufacturing technique suitable for the purpose of this disclosure. Components of embodiments of this disclosure can be attached or otherwise joined according to any attachment mechanisms suitable for the purposes of this disclosure. For example, components may be screwed, latched, clasped, clamped, stapled, fused, bonded, glued, welded, and/or compression fit together.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. An animal rescue vault configured for placement inside a pool skimmer well, comprising:
an arched sidewall of increasing thickness running from a pair of distal cusps to a peak occuring at a symmetric centerline;
a plurality of legs affixed to and protruding downward around the sidewall; and
a ramped surface atop said sidewall, said ramped surface extending at one end from a lip that protrudes below said sidewall to an opposing end elevated to said peak;
whereby a majority of the area of both the arched sidewall and ramped surface comprises a perforated mesh for passing water.

2. The animal rescue vault of claim 1, wherein said arched sidewall partially circumscribes an oval.

3. The animal rescue vault of claim 1, wherein said plurality of legs comprises four legs arranged in two pair, one pair of legs on each side of the symmetric centerline the sidewall.

4. The animal rescue vault of claim 3, wherein said plurality of legs flare outward from said sidewall.

5. The animal rescue vault of claim 3, wherein said plurality of legs are equi-angularly spaced around the sidewall.

6. The animal rescue vault of claim 2, wherein said plurality of legs are all flat and oriented tangent to the oval sidewall.

7. The animal rescue vault of claim 1, wherein said sidewall, ramped surface and plurality of legs are integrally-molded.

8. The animal rescue vault of claim 1, wherein said ramped surface rises at an incline of about 45 degrees when said animal rescue vault is standing horizontally on said pluraility of legs.

9. The animal rescue vault of claim 1, wherein said sidewall is about 8.40″ long and 7.01″ wide.

10. The animal rescue vault of claim 1, wherein said ramped surface rises from 1.87″ high to approximately 5.59″ high standing horizontally on said pluraility of legs.

11. The animal rescue vault of claim 1, wherein the perforations of said mesh occupy a majority of the surface area of the ramped surface.

12. The animal rescue vault of claim 1, wherein the perforations of said mesh occupy a majority of the surface area of the sidewall.

13. An animal rescue vault configured for placement inside a pool skimmer well, comprising:
an arched sidewall of increasing thickness running from a pair of distal cusps to a peak occuring at a symmetric centerline;
a plurality of legs affixed to and protruding downward around the sidewall, said plurality of legs comprising four flat legs arranged in two pair on opposing sides of the the symmetric centerline the sidewall, each flat leg being oriented tangent to the arc of said sidewall; and
a ramped surface atop said sidewall, said ramped surface extending at one end from a lip that protrudes below said sidewall to an opposing end elevated to said peak;
whereby a majority of the area of both the arched sidewall and ramped surface comprises a perforated mesh for passing water.

14. The animal rescue vault of claim 13, wherein said arched sidewall partially circumscribes an oval.

15. The animal rescue vault of claim 14, wherein said plurality of legs flare outward from said sidewall.

16. The animal rescue vault of claim 14, wherein said plurality of legs are equi-angularly spaced around the sidewall.

17. The animal rescue vault of claim 13, wherein said sidewall, ramped surface and plurality of legs are integrally-molded.

18. The animal rescue vault of claim 13, wherein said ramped surface rises at an incline of about 45 degrees when said animal rescue vault is standing horizontally on said pluraility of legs.

19. The animal rescue vault of claim 13, wherein said ramped surface rises from 1.87″ high to approximately 5.59″ high standing horizontally on said pluraility of legs.

20. The animal rescue vault of claim 1, wherein the perforations of said mesh occupy a majority of the surface area of both the ramped surface and sidewall.
